(19) United States
(12) Patent Application Publication
(10) Pub. No.: US 2008/0208517 A1
(43) Pub. Date: Aug. 28, 2008

(54) Enhanced Single-Sensor Position Detection

(75) Inventor: Atid Shamaie, Ottawa (CA)

Correspondence Address: FISH & RICHARDSON P.C., P.O. BOX 1022, MINNEAPOLIS, MN, 55440-1022, US

(73) Assignee: GESTURETEK, INC., New York, NY (US)

(21) Appl. No.: 12/035,616

(22) Filed: Feb. 22, 2008

Related U.S. Application Data
(60) Provisional application No. 60/891,404, filed on Feb. 23, 2007.

(51) Int. Cl. G06F 15/00

(52) U.S. Cl. 702/142; 702/150

(57) ABSTRACT

Enhanced single-sensor position detection, in which a position of an object is determined. In some implementations, a first signal is emitted from a first emitter, and a second signal is emitted from a second emitter. A plane is monitored using a sensor, and the first signal and the second signal are received at the sensor after each of the first signal and the second signal reflect off of the object. A response signal is generated based on the first and second signals, and the response signal is processed to determine the position of the object in the plane.

### CROSS REFERENCE TO RELATED APPLICATIONS

This application claims the benefit of U.S. Provisional Application No. 60/891,404, Feb. 23, 2007, the contents of which are hereby incorporated by reference for all

### FIELD

The present disclosure generally relates to position detection, and at least one particular implementation relates to identifying a position of and/or tracking an object in multi-dimensional space using at least one sensor.

### BACKGROUND

In the field of computer vision, different techniques exist for finding the position of an object, and for tracking the object in two or three-dimensional space. Estimating the position of an object in two or three-dimensional space typically requires a pair of sensors. Exemplary sensors can include cameras in an arrangement known as stereovision. Although stereovision is one example conventional technology for detecting the position of an object in two or three-dimensional space, cameras with sufficiently high-resolution are expensive. Further, the accuracy of the position detection is often difficult to estimate due to numerous distortions.

### SUMMARY

The present disclosure is directed to various implementations of processes and systems for determining the position of an object. In some implementations, a first signal is emitted from a first emitter, and a second signal is emitted from a second emitter. A plane is monitored using a sensor, and the first signal and the second signal are received at the sensor after each of the first signal and the second signal reflect off of the object . A response signal is generated based on the first and second signals, and the response signal is processed to determine the position of the object in the plane.

In one feature, first and second geometric shapes can be determined based on the signal, and the position of the object can be determined based on an intersection point of the geometric shapes. In another feature, first flight time of the first signal, and a second flight time of the second signal are determined, and the position of the object is determined based on the first and second flight times. In other features, a channel that focuses the first and second signals is provided. In one implementation, the channel can be located between the sensor and the plane. In another implementation, the channel can be located between at least one of the first and second emitters and the plane.

In other features, the first signal can include a first frequency, the second signal can include a second frequency, and the sensor can include a sampling rate, at which the first and second signals are sampled. The sampling rate can include a sampling frequency that is greater than both the first and second frequencies. In one implementation, the sampling frequency can be at least ten times greater than both the first or second frequencies In still another feature, the sensor can be located between the first and second emitters. In yet another feature, the first and second emitters, and the sensor can be aligned along a common axis.

The present disclosure further describes various implementations of processes and systems for tracking movement of an object. In some implementations, a first signal is emitted from a first emitter, and a second signal is emitted from a second emitter. A first plane is monitored using a first sensor, and the first signal and the second signal can be received at the first sensor after each of the first signal and the second signal reflect off of the object in the first plane. A first response signal can be generated based on the first and second signals, and the first response signal can be processed to determine a first position of the object at a first time.

In another feature, the first response signal can be processed to determine a second position of the object, and a movement of the object can be determined based on the first position and the second position. In another feature, the first response signal can be processed to determine a second position of the object at a second time, and a velocity of the object can be determined based on the first and second positions, and the first and second times.

In still other features, a second plane can be monitored using a second sensor, and the first signal and the second signal can be received at the second sensor after each of the first signal and the second signal reflect off of the object in the second plane. A second response signal can be generated based on the first and second signals, and the second response signal can be processed to determine a second position of the object at a second time. In one implementation, a movement of the object between the first and second planes can be determined based on the first and second positions. In another implementation, a velocity of the object between the first and second planes can be determined based on the first and second positions, and the first and second times.

In a further general implementation, a computer-implemented process includes outputting automatically determined coordinates of an object within a plane based on receiving, at a single sensor, different frequency signals previously emitted in the plane and reflected off of the object.

In still another general implementation, a computer readable medium can be encoded with a computer program product, tangibly embodied-in an information carrier. The computer program product can induce a data processing apparatus to perform operations in accordance with the present disclosure. In some implementations, the data processing apparatus can induce a first emitter to emit a first signal, and can induce a second emitter to emit a second signal. The data processing apparatus can instruct a sensor to monitor a plane, and can receive a response signal from the sensor, the response signal being based on the first and second signals after each of the first signal and the second signal reflect off of the object. The data processing apparatus can process the response signal to determine the position of the object in the plane.

The details of one or more implementations are set forth in the accompanying drawings and the description below. Other features and advantages will be apparent from the description and drawings.

### DESCRIPTION OF DRAWINGS

FIG. 1 illustrates a position detection system including two emitters, a sensor and a processor, according to one general implementation.

FIGS. 2A and 2B depicts exemplary arrangements of a position detection system.

FIGS. 3A to 3C illustrates exemplary emission patterns and sampling rate.

FIG. 4A illustrates an object on a two-dimensional plane reflecting radiation of two emitters to a single sensor.

FIG. 4B illustrates movement of an object on a two-dimensional plane that is monitored to regulate movement of a cursor on a display.

FIG. 5 illustrates a signal diagram of the reception of emitted radiation.

FIG. 7 depicts a side view of an exemplar object tracking system.

FIG. 8 depicts a flowchart illustrating an exemplar process that can be executed in accordance with the present disclosure.

FIG. 9 is a functional block diagram of an exemplar computer system that can process a computer readable medium.

### DETAILED DESCRIPTION

According to one general implementation, a single sensor position detection system is provided, which accurately detects the position of an object using multiple sources of electromagnetic radiation, light, or ultrasound. For instance, the system may be used to output automatically determined coordinates of an object within a plane based on receiving, at a single sensor, different frequency signals previously emitted in the plane and reflected off of the object.

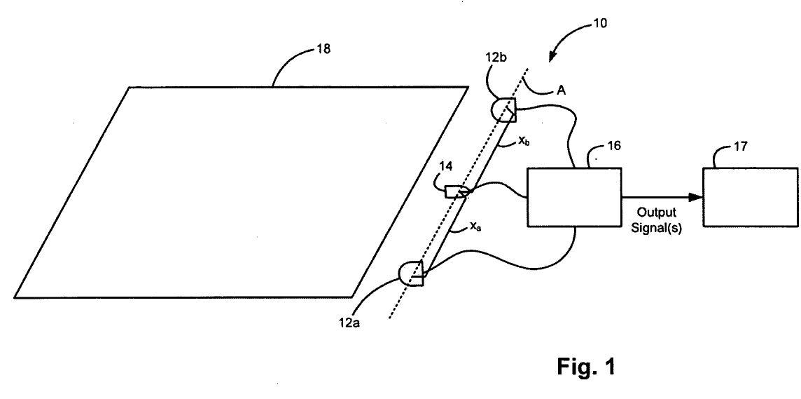

Referring now to FIG. 1, a position detection system 10 includes two emitters 12a, 12b, and a single sensor 14. Emitters 12a, 12b are located on either side of sensor 14, and can be aligned along a common axis A. Emitter 12ais separated from sensor 14 by a distance xₐ, and emitter 12b is separated from sensor 14 by a distance x_{b}. In various configurations, xₐ and x_{b} are known, and can either be equal or non-equal, and can be located on the same side or opposite sides of sensor 14.

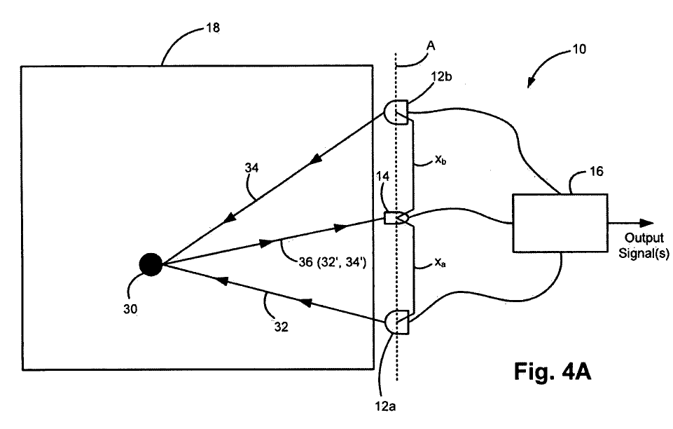

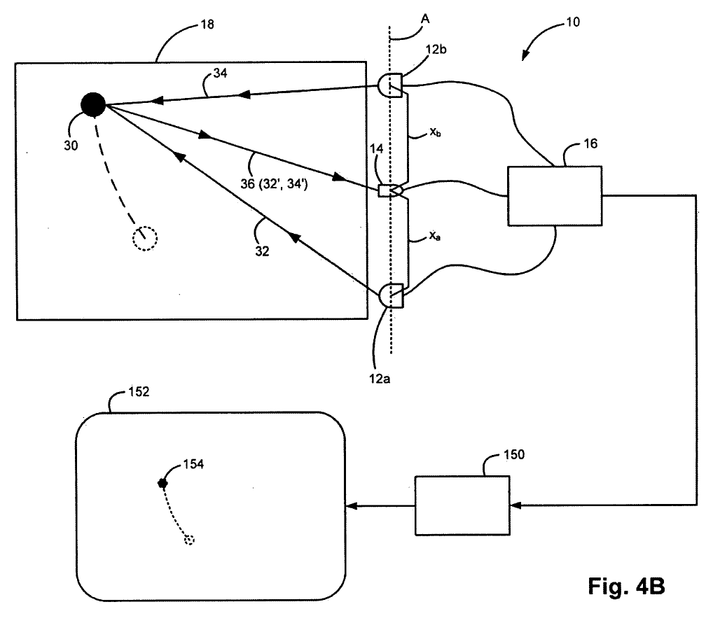

Position detection system 10 further includes a module 16 that is in communication with emitters 12a, 12b, and sensor 14. Module 16 regulates operation of emitters 12a, 12b, and receives a response signal from sensor 14. Module 16 can process the response signal to determine a position of an object in a multi-dimensional space, as described in further detail herein. An exemplar multi-dimensional space includes a two-dimensional plane, or surface 18, on which the position of the object is intended to be calculated. A usable output signal can be generated by module 16, which can be output to a control module 17. Control, module 17, which can be a computer, can regulate operation of another component, such as a display, based on the output signal. A non-limiting example of such control is discussed in detail below with respect to FIGS. 4A and 4B.

In operation, emitters 12a, 12b emit a signal across surface 18. The signal can include, but is not limited to, electromagnetic radiation, light (e.g., a line laser), and/or ultrasound. In one implementation, line laser type emitters can be used to produce a thin layer of laser light parallel to surface 18. In another implementation, emitters 12a, 12b can each emit the signal in a three-dimensional (3D) volume that can include, but is not limited to, a cone. The signal reflects off an object that is at least partially positioned on plane 18. The reflected signal is detected by sensor 14, which generates the response signal based thereon.

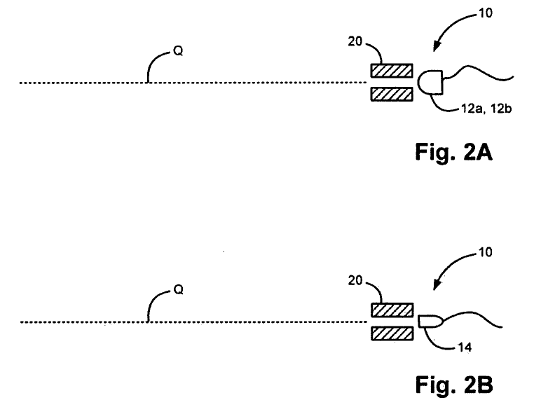

Referring now to FIGS. 2A and 2B, the emitted signals, and/or the reflected signal can be focused to generally radiate within a plane Q. With particular reference to FIG. 2A, a channel 20 can be positioned between surface 18 and emitter 12a, and/or 12b. Channel 20 can be arranged to focus the emitted signal substantially in plane Q. More specifically, channel 20 can block the signal in many directions except a thin layer that is substantially within or parallel to plane Q, and that is substantially parallel to surface 18. With particular reference to FIG. 2B, channel 20 can be positioned between surface 18 and sensor 14, and can block the reflected radiation in many directions except a thin layer that is substantially within or parallel to plane Q, and that is substantially parallel to surface 18. In other implementations, a plurality of channels can be implemented. For example, channels can be located between surface 18 and sensor 14, as well as between surface 18 and emitter 12a, and/or emitter 12b.

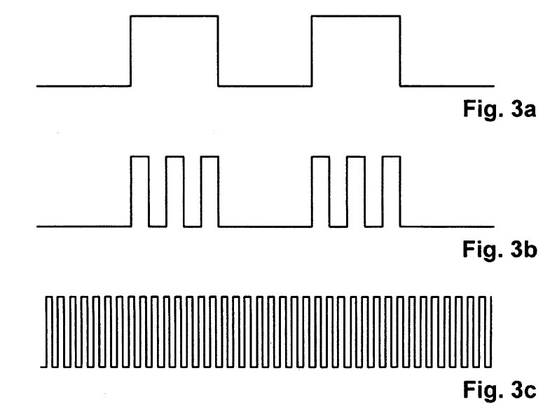

FIGS. 3A and 3B illustrate exemplar signal patterns for two emitters. The exemplar signal pattern of FIG. 3A includes a square wave pattern of intermittent pulses having a first frequency. The exemplar signal pattern of FIG. 3B includes a square wave pattern of intermittent pulses having a second, frequency. Although the exemplar signal patterns of FIGS. 3A and 3B include square wave patterns, it is anticipated that other wave patterns, wavelengths, and/or frequencies can be implemented. In this implementation, sensor 14 may concurrently sense the signal emitted by both emitters 12a, 12b, which each emit in a particular pattern with a particular frequency. For example, emitter 12a may emit a signal with the pattern shown in FIG. 3A, and emitter 12b may emit another signal with the pattern shown in FIG. 3B. In other implementations, the emitted signal patterns may or may not be synchronized.

FIG. 3C illustrates an exemplar sampling rate of sensor 14. In one general implementation, the sampling rate of sensor 14 has a frequency that is greater than the intermittent pulse frequency of either emitter 12a, or emitter 12b. By way of non-limiting example, one or more of emitters 12a, 12b can emit a signal at a frequency of 300 GHz, or higher, and sensor 14 can sample at a frequency of 3000 GHz, or higher. Accordingly, sensor 14 samples at a frequency that can be approximately ten times the emission frequency of emitters 12a, 12b, in this non-limiting example. In this manner, sensor 14 has a sufficient resolution to more accurately detect the change in the wave pattern of emitters 12a, 12b. In fact, if the sensor has a high frequency, such as a frequency which is much higher than that of the emitters, then the accuracy of calculations increases. The appropriate frequencies of the emitters and the sensor may depend on the type of wave pattern selected. Sensor 14 samples the received waves, and generates the response signal, as explained in further detail below.

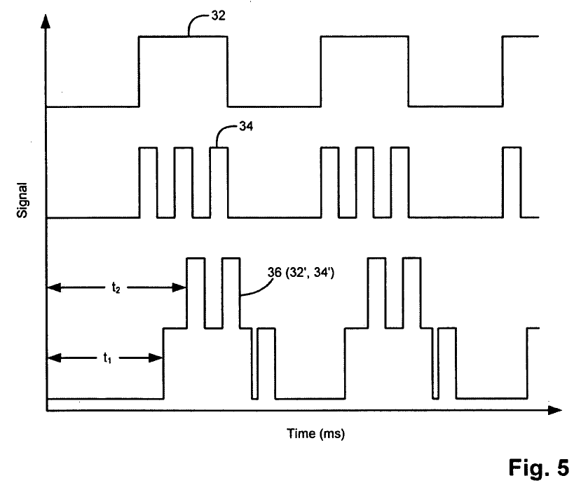

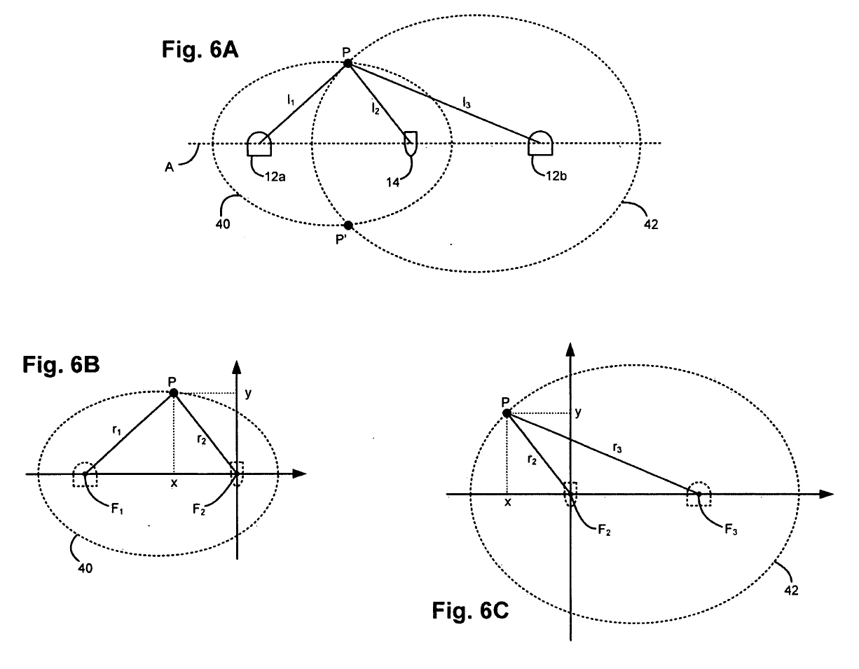

Referring now to FIGS. 4A and 5, operation of position detection system 10 will be described in detail. FIG. 4A is a plan view of the position detection system 10 of FIG. 1, and illustrates an object 30 on surface 18 reflecting the signals of emitters. Emitters 12a, 12b emit respective signals 32, 34, which reflect off of object 30 to provide a reflected signal 36. Reflected signal 36 includes a compound signal that includes a reflected signal 32′ and a reflected signal 34′. FIG. 5 illustrates wave patterns of the respective signals 32, 34, 36. A time t₁, indicates the time between signal 32 being emitted by the emitter 12a, and the moment that sensor 14 receives the reflected signal 32′. Accordingly, time t₁ includes the time signal 32 travels from emitter 12a, hits object 30, and travels to sensor 14. Sampling at a high frequency, sensor 14 may measure this time of flight, where increased sampling rates correspond to an increased resolution, and thus improved accuracy of the measured time. A time t₂ indicates the time between the signal 34 being emitted by emitter 12b, and the moment that sensor 14 receives the reflected signal 34′. Accordingly, time t₂ includes the time signal 34 travels from emitter 12b, hits object 30, and travels to sensor 14. Consequently, an activation moment of each signal 32, 34 is individually determined.

The position of object 30 can be determined based on the times t₁ and t₂. More specifically, given times t₁ and t₂, the distance each signal has traveled,in space is calculated based on the type of signal. For example, if the signal is provided as light, the distance for the given time t is expressed by Equation (1), below, where v represents the speed of light:

d=v· (1)

In general, v represents the speed, or rate of propagation of the particular signal, whether the signal includes electromagnetic radiation, light, or ultrasound.

Referring now to FIGS. 4A and 4B, position detection system 10 can be used to track movement of object 30 on surface 18. The plan view of FIG. 4A illustrates object 30 in a first position on surface 18, while the plan view of FIG. 4B illustrates object 30 in a second position on surface 18. Emitters 12a, 12b emit respective signals 32, 34, which reflect off of object 30 as it moves from the first position of FIG. 4A to the second position of FIG. 4B, providing reflected signal 36. Reflected signal 36 can be processed to determine characteristics of the movement of object 30 that can include, but are not limited to, the first position, the second position, the path traveled, and/or the velocity of object 30 as it travels on surface 18. This information can be used in various applications. By way of one non-limiting example, the movement information can be output by the module 16 and input to a display control module 150 that controls a display 152. More specifically, display control module 150 can regulate display 152 to display-a cursor 154 (see FIG. 4B). Movement of cursor 154 on display 152 can be regulated based on the movement information such that the movement of cursor 154 corresponds to movement of object 30.

Referring now to FIGS. 6A-6C the position of object 30 can be determined using geometric shapes, in this case, ellipses 40, 42. A distance d₁ that signal 32 travels from emitter 12a to sensor 14 is equal to the sum of the distances l₁, l₂ of FIG. 6A. A distance d₂ that signal 34 travels from emitter 12b to sensor 14 is equal to the sum of the distances l₂, l₃ of FIG. 6A.

Ellipses 40, 42 intersect at points P and P′. However, one of these points, point P, indicates the actual position of object 30. By forming analytical equations of the ellipses, the position of object 30 can be determined. Here, it can be assumed that emitters 12a, 12b , and sensor 14 are positioned on a straight line, although in an alternate implementation emitters 12a, 12b and/or sensor 14 are not oriented linearly relative to one another. This approach may also be used to find the position of object 30 with respect to the position of sensor 14. In other words, sensor 14 can be considered to be at the origin of a Cartesian plane. Further, the line A passing through emitters 12a, 12b and sensor 14 can be considered to be the x-axis of the Cartesian plane.

With particular reference to FIG. 6B, emitter 12a and sensor 14 define the foci F₁, F₂, respectively, of ellipse 40. Foci F₂ (i.e., sensor 14) is at the origin of the Cartesian plane, and thus includes the (x, y) coordinates (0, 0). F₁ is at the (x, y) coordinates (−2c, 0), where c>0. The values of r₁ and r₂ may be used as expressed below in Equations (2) to (4), below:

In Equations (2) to (4), r1 and r2 are the respective distances of point P to the foci F₁, F2. 2a is the distance measured by the time of flight, where 2a=d1. Equations (5) to (7), below, are based on Equations (2) to (4):

r₁²=(x+2c)²y² (2)

r₂²=x²+y² (3)

r₁+r₂=\sqrt{(x+2c)²+y²}+\sqrt{x²+y²}=2a (4)

In Equations (2) to (4), r₁ and r₂ are the respective distances of point P to the foci F₁, F₂. 2a is the distance measured by the time of flight, where 2a=d1. Equations (5) to (7), below, are based on Equations (2) to (4):

$$\begin{matrix}{( x + 2 c )}^{2} + {y}^{2} = 4 {a}^{2} + {x}^{2} + {y}^{2} - 4 a \sqrt{{x}^{2} + {y}^{2}} & ( 5 ) \\ \sqrt{{x}^{2} + {y}^{2}} = a - \frac{{c}^{2}}{a} - \frac{c}{a} x & ( 6 ) \\ {y}^{2} = ( \frac{{c}^{2}}{{q}^{2}} - 1 ) {x}^{2} + ( \frac{2 {c}^{3}}{{a}^{2}} - 2 c ) x + \frac{{c}^{4}}{{a}^{2}} + {a}^{2} - 2 {c}^{2} & ( 7 )\end{matrix}$$

With particular reference to FIG. 6C, sensor 14 and emitter 12b define the respective foci F₂, F₃ of ellipse 42. Accordingly, ellipse 40 and ellipse 42 share a common focal point. Again, foci F₂ (i.e., sensor 14) is at the origin of the Cartesian plane, and thus includes the (x, y) coordinates (0, 0). F₃ is at the (x, y) coordinates (0, 2d), where d>0. The values of r₂ and r₃ may be variously used as expressed below in Equations (8) to (10):

r₂²x²+y² (8)

r₃²=(x−2d)²y² (9)

r₂+r₃=\sqrt{(x−2d)²+y²}+\sqrt{x²+y²}==2b (10)

In Equations (8) to (10), 2b is the distance measured by the time of flight from emitter 12b to sensor 14. Equation (11), below, is based upon Equations (8) to (10):

$${y}^{2} = ( \frac{{d}^{2}}{{b}^{2}} - 1 ) {x}^{2} + ( 2 d - \frac{2 {d}^{3}}{{b}^{2}} ) x + {b}^{2} - 2 {d}^{2} + \frac{{d}^{4}}{{b}^{2}} \qquad ( 11 )$$

More specifically, Equation (11) is determined by applying the same calculations to Equations (8) to (10) as applied to Equations (2) to (4) in arriving at Equation (7). Equations (7) and (11) represent two equations in which two unknowns exist. Equation (12), below, represents a system of equations including Equation (7) and Equation (11):

$$\{ \begin{matrix}{y}^{2} = ( \frac{{c}^{2}}{{a}^{2}} - 1 ) {x}^{2} + ( \frac{2 {c}^{3}}{{a}^{2}} - 2 c ) x + \frac{{c}^{4}}{{a}^{2}} + {a}^{2} - 2 {c}^{2} \\ {y}^{2} = ( \frac{{d}^{2}}{{b}^{2}} - 1 ) {x}^{2} + ( 2 d - \frac{2 {d}^{3}}{{b}^{2}} ) x + \frac{{d}^{4}}{{b}^{2}} + {b}^{2} - 2 {d}^{2}\end{matrix} \qquad ( 12 )$$

Solving the system of equations represented by Equation (12) results in a determination of values for the intersection points of ellipses 40, 42 (i.e., P and P′ in FIG. 6A). Because the x-axis has been defined as the straight line A passing through emitters 12a, 12b, and sensor 14, and the intersection points are symmetrical with respect to the x-axis, P may be distinguished from P′ by analyzing the sign of the y-coordinates of the points.

In other implementations, the position detection system can include a third-emitter. In this implementation, the position of an object in a 3D space may be determined. In one example, the third emitter is not linearly positioned or oriented with the other two emitters. In a 3D space, prolate spheroids (i.e. ellipsoids) are implemented instead of the 2D ellipses described above with respect to FIGS. 6A-6C. Each ellipsoid may represent all of the points in the space for which the distances to the two foci is a constant value measured by the time of flight technique. In order to find the position of the object in the 3D space, the intersecting points of the three ellipsoids are determined, using an algorithm for calculating the intersecting points of multiple ellipsoids in a 3D space.

In some implementations, the position detection system 10 can be used to determine the position or coordinates of an object on a plane. In other implementations, the position detection system 10 can determine the position of the object in the plane, as well as track a movement of the object on the plane. For example, the position detection system 10 can intermittently determine the position of the object. The rate at which the position detection system samples, or determines the position can vary. The higher the sampling rate, the better resolution of movement is provided. By intermittently sampling the position of the object on the plane, a plurality of position values can be generated. The position values can be compared to one another to determine a path of movement of the object, as well as the rate at which the object moves (i.e., the velocity of the object).

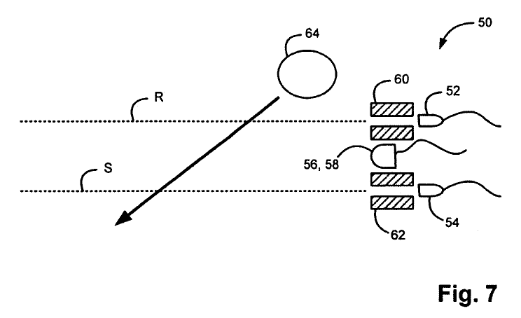

Referring now to FIG. 7, another implementation of a position detection system 50 includes first and second sensors 52, 54, respectively, and emitters 56, 58. FIG. 7 depicts a side view of position detection system 50. Accordingly, although position detection system 50 includes two emitters 56, 58, only one emitter is visible. Respective channels 60, 62 can be located in front of sensors 52, 54. In this manner, sensors 52, 54 can receive reflected signals from respective monitoring planes R and S. More specifically, emitters 56, 58 can emit signals, as described in detail above. The emitted signals can reflect off an object 64 that is either within, or passing through the respective monitoring planes R, S.

In one example of the operation of position detection system 50, as object 64 passes through monitoring plane R, signals from emitters 56, 58 can reflect off of object 64, and the reflected signals can be received by sensor 52. Sensor 54 is inhibited from receiving the reflected signals by channel 62. Consequently, a position of object 64 within monitoring plane R can be determined. As object 64 continues and passes through monitoring plane S, signals from emitters 56, 58 can reflect off of object 64, and the reflected signals can be received by sensor 54. Sensor 52 is inhibited from receiving the reflected signals by channel 60. Consequently, a position of object 64 within monitoring plane S can be determined.

By further processing of the response signals generated by sensors 52, 54, movement of object 64 can be tracked. More specifically, the velocity at which object 64 is traveling can be determined by comparing the times, at which object 64 is detected in each of monitoring planes R, S. For example, a distance between monitoring planes R, S can be a known, fixed value. Given the distance between monitoring planes R, S, and the times, at which object 64 is detected in each of monitoring planes R, S, the vertical velocity of object 64 can be determined with respect to FIG. 7. Further, the path, along which object 64 is traveling, can be determined by comparing the position of object 64 in monitoring plane R to the position of object 64 in monitoring plane S. Although the implementation of FIG. 7 includes one set of emitters, and two sensors to provide two monitoring planes (i.e., one sensor per monitoring plane), other implementations can include additional monitoring planes, and can include additional sensors and/or emitters to establish the additional monitoring planes.

With continued reference to FIG. 7, monitoring plane R can be implemented to detect hovering of an object, such as a finger, for example, over a surface, such as a touch-screen, for example. Monitoring plane S can be implemented to determine where the object actually contacts the surface. For example, a touch-screen user can hover his/her finger over the touch-screen, as the user decides which option to selection the touch-screen. This hovering motion can be monitored using the monitoring plane R. When the user makes a-selection and actually touches the screen, the position of the actual contact can be determined using the monitoring plane S.

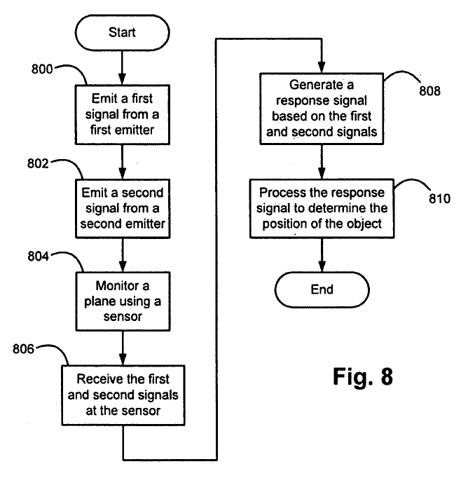

Referring now to FIG. 8, an exemplar process that can be executed in accordance with the present disclosure will be described. More specifically, the exemplar process can be executed to determine a position of an object in a multi-dimensional space including, but not limited to, a 2D plane. In step 800, a first signal is emitted from a first emitter. In step 802, a second signal is emitted from a second emitter, at a time before, after or concurrently with the emission of the first signal. A plane is monitored using a sensor in step 804. In step 806, the first signal and the second signal are received at the sensor after each of the first signal and the second signal reflect off of the object. A response signal is generated based on the first and second signals in step 808, and the response signal is processed in step 810 to determine the position of the object in the plane. It is appreciated that steps 800 to 810 can be repeated to continuously determine the position of the object. In other implementations, the exemplar steps can further include determining first and second geometric-shapes-based on the response signal, and determining the position of the object based on an intersection point of the geometric shapes. In still other implementations, the exemplar steps can further include determining a first flight time of the first signal, and a second flight time of the second signal, and determining the position of the object based on the first and second flight times.

Implementations of a position detection system have been described, in which the position of an object can be determined using two signal sources, and a single sensor. The position detection technique is based on calculating the time of flight for the signals emitted by the respective sources, and received by a single sensor. By forming equations of two separate geometric shapes, ellipses in the present example, and finding the intersection points of these ellipses, the position of the object in a 2D monitoring plane may be calculated. In other implementations, multiple monitoring planes can be provided, which run parallel to one another, for tracking the path, and/or determining the velocity of a moving object. In still other implementations, a 3D version of the technique can be configured to determine the position of an object in a 3D space has also been described.

The implementations of the position detection system described herein, can be used to make interactive systems, which determine and/or track the position of an object including, but not limited to, a hand, or a finger. In general, implementations of the position detection system can be used to make position detecting equipment for a variety of applications. For example, implementations of the position detection system can be used in a touch-screen application to determine the position of a finger or other pointer, for example, as a user selects options by touching a screen, or for tracking the movement of a pointer on a screen to monitor writing, and/or drawing on the screen. In other examples, implementations of the position detections system can be used for entertainment applications. In one exemplary application, the motion of the head of a golf club, and/or the flight path of a golf ball can be tracked through a plurality of monitoring planes to assist improving a golfer's stroke, or as part of a video game system. In another exemplary application, the motion of a drawing pen can be tracked in a monitoring plane, to provide a digital copy of a drawing, and/or writing.

In general, implementations of the present disclosure may include, for example, a process, a device, or a device for carrying out a process. For example, implementations may include one or more devices configured to perform one or more processes related to determining the position of an object, as described in detail above. A device may include, for example, discrete or integrated hardware, firmware, and software. A device may include, for example, computing device or another computing or processing device, particularly if programmed to perform one or more described processes or variations thereof. Such computing or processing devices may include, for example, a processor, an integrated circuit, a programmable logic device, a personal computer, a personal digital assistant, a game device, a cell phone, a calculator, and a device containing a software application.

Implementations also may be embodied in a device that includes one or more computer readable media having instructions for carrying out one or more processes for determining the position of an object. The computer readable media may include, for example, storage device, memory, and formatted electromagnetic waves encoding or transmitting instructions. The computer readable media also may include, for example, a variety of non-volatile and/or volatile memory structures, such as, for example, a hard disk, a flash memory, a random access memory, a read-only memory, and a compact diskette. Instructions may be, for example, in hardware, firmware, software, and in an electromagnetic wave.

The computing device may represent an implementation of a computing device programmed to perform the position detection calculations, as described in detail above, and the storage device may represent a computer readable medium storing instructions for carrying out a described implementation of the object position detection.

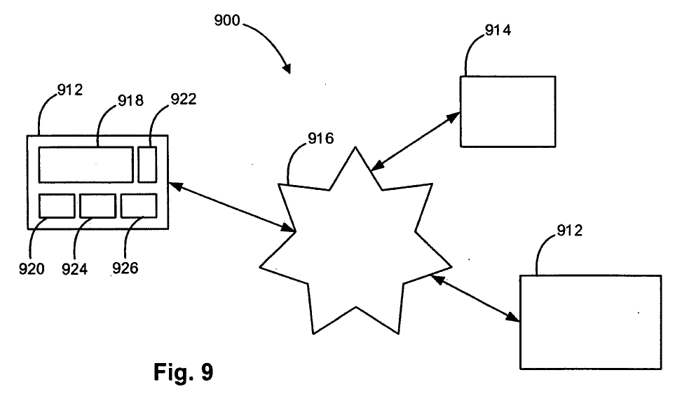

Referring now to FIG. 9, the various implementations of the present disclosure can be implemented by computer systems and computer programs. More specifically, the implementation of the present disclosure can be provided in computer readable medium encoded with a computer program product, such as software. The computer program product can be processed to inducing a data processing apparatus to execute one or more implementations of the present disclosure. FIG. 9 illustrates an exemplar computer network 910 that includes a plurality of computers 912, and one or more servers 914 that communicate with one another over a network 916. Network 916 can include, but is not limited to, a local area network (LAN), a wide area network (WAN), and/or the Internet. An exemplar computer 912 includes a display 918, an input device 920, such as a keyboard and/or mouse, memory 922, a dataport 924, and a central processing unit (CPU) 926. Display 918 can include a touch-screen that is monitored in accordance with the present disclosure, and thus can also serve as an input device. A computer program product (e.g., a software program), which executes one or more implementations of the process of the present disclosure, can be resident on one or more of computers 912, and/or on the server 914.

The computer program product can induce a data processing apparatus, such as CPU 926 to perform operations in accordance with implementations of the present disclosure. For example, the computer program product can induce the data processing apparatus to induce a first emitter to emit a first signal, and induce a second emitter to emit a second signal. The data processing apparatus can insutruct a sensor to monitor a plane,such as a screen display 918, and can receive a response signal frpm the sensor. The response signal can be based on the first and second signals after each of the first signal and the second signal reflect off of the object. The data processing apparatus can process the response signal to determine the position of the object in the plane.

A number of implementations have been described. Nevertheless, it will be understood that various modifications may be made. Accordingly, other implementations are within the scope of the disclosure.

What is claimed is:

1. A system for determining a position of an object, comprising:
a first signal emitter that selectively emits a first signal;
a second signal emitter that selectively emits a second signal;
a sensor that monitors a plane, that receives the first signal and the second signal after each of the first signal and the second signal reflect off of the object, and that generates a response signal based on the first and second signals; and
a processor that is configured to process the response signal and determine the position of the object in the plane based on the response signal.

2. The system of claim 1, wherein the processor is further configured to determine first and second geometric shapes based on the response signal, and to determine the position of the object based on an intersection point of the geometric shapes.

3. The system of claim 1, wherein the processor is further configured to determine a first flight time of the first signal, and a second flight time of the second signal, and to determine the position of the object based on the first and second flight times.

4. The system of claim 1, further comprising a channel that focuses the first and second signals.

5. The system of claim 1, wherein the first signal includes a first frequency, the second signal includes a second frequency, and the sensor includes a sampling rate, at which the first and second signals are sampled.

6. The system of claim 5, wherein the sampling rate includes a sampling frequency that is greater than both the first and second frequencies.

7. The system of claim 1, wherein the first and second emitters, and the sensor are aligned along a common axis.

8. A method of determining a position of an object, comprising:
emitting a first signal from a first emitter;
emitting a second signal from a second emitter;
monitoring a plane using a sensor;
receiving the first signal and the second signal at the sensor after each of the first signal and the second signal reflect off of the object;
generating a response signal based on the first and second signals; and
processing the response signal to determine the position of the object in the plane.

9. The method of claim 8, further comprising:
determining first and second geometric shapes based on the response signal; and
determining the position of the object based on an intersection point of the geometric shapes.

10. The method of claim 8, further comprising:
determining a first flight time of the first signal, and a second flight time of the second signal; and
determining the position of the object based on the first and second flight times.

11. The method of claim 8, further comprising providing a channel that focuses the first and second signals.

12. The method of claim 8, wherein the first signal includes a first frequency, the second signal includes a second frequency, and the sensor includes a sampling rate, at which the first and second signals are sampled.

13. The method of claim 12, wherein the sampling rate includes a sampling frequency that is greater than either the first and second frequencies.

14. The method of claim 8, further comprising aligning the first and second emitters, and the sensor along a common axis.

15. A method of tracking movement of an object, comprising:
emitting a first signal from a first emitter;
emitting a second signal from a second emitter;
monitoring a first plane using a first sensor;
receiving the first signal and the second signal at the first sensor after each of the first signal and the second signal reflect off of the object in the first plane;
generating a first response signal based on the first and second signals; and
processing the first response signal to determine a first position of the object at a first time.

16. The method of claim 15, further comprising:
processing the first response signal to determine a second position of the object; and
determining a movement of the object based on the first position and the second position.

17. The method of claim 15, further comprising:
processing the first response signal to determine a second position of the object at a second time; and
determining a velocity of the object based on the first and second positions, and the first and second times.

18. The method of claim 15, further comprising:
monitoring a second plane using a second sensor;
receiving the first signal and the second signal at the second sensor after each of the first signal and the second signal reflect off of the object in the second plane;
generating a second response signal based on the first and second signals; and
processing the second response signal to determine a second position of the object at a second time.

19. The method of claim 18, further comprising determining a movement of the object between the first and second planes based on the first and second positions.

20. The method of claim 18, further comprising determining a velocity of the object between the first and second planes based on the first and second positions, and the first and second times.

21. A computer-implemented method comprising outputting automatically determined coordinates of an object within a plane based on receiving, at a single sensor, different frequency signals previously emitted in the plane and reflected off of the object.

22. A computer readable medium encoded with a computer program product, tangibly embodied in an information carrier, the computer program product inducing a data processing apparatus to perform operations comprising:
inducing a first emitter to emit a first signal;
inducing a second emitter to emit a second signal;
instructing a sensor to monitor a plane;
receiving a response signal from the sensor, the response signal being based on the first and second signals after each of the first signal and the second signal reflect off of the object; and
processing the response signal to determine the position of the object in the plane.
